(19) United States
(12) Patent Application Publication
(10) Pub. No.: US 2025/0335188 A1
(43) Pub. Date: Oct. 30, 2025

(54) QUANTIFYING A RELATIONSHIP BETWEEN AN OPEN-SOURCE PACKAGE AND SOURCE CODE IN A REPOSITORY

(71) Applicant: Stacklok, Inc., Seattle, WA (US)

(72) Inventors: Pankaj Telang, Cary, NC (US); Nigel Brown, Devon (GB)

(21) Appl. No.: 18/649,613

(22) Filed: Apr. 29, 2024

(51) Int. Cl. G06F 8/71; G06F 8/77

(52) U.S. Cl. CPC G06F 8/71; G06F 8/77

(57) ABSTRACT

Techniques for quantifying a relationship between an open-source package and source code of a repository are disclosed. Package versions, each having a version name and a version date, are obtained from an executable software exchange. A project of a source code exchange is selected, wherein the project is identified by the package as a source from which the package is derived. Project tags established for the project are obtained, each project tag having a tag name and a tag date. A count of each matching package version and project tag is determined, wherein a match is determined by establishing that a name and date of the package version match a name and date of a project tag. A relationship score is determined based on the count of each matching package version and project tag.

### BACKGROUND

Open-source software is software the public may use, modify, or distribute. Open-source software can be released in two different forms: (1) source code in which the software is originally authored; or (2) executable code by which the software can be executed. It is common for those responsible for creating open-source software to release its source code in a source code repository such as GitHub. Developers or others can then release executable code for the open-source software that is based on this source code as a package via a package repository such as PyPI or Maven. The package can in turn be incorporated into various software projects to provide various functionalities.

For example, a first open-source project may be developed in the C++ programming language, and its source code released in a source code repository. The creators or others can compile this C++ source code to obtain a binary executable and release the binary executable in a package repository. Others can download the binary executable from the package repository and incorporate it into a software project.

When source code is released to a repository, it is common practice to assign the source code a tag to identify the source code. Similarly, when a package is released to a package repository, it is common practice to assign the package a version to identify the package.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a block diagram showing some of the components typically incorporated in at least some of the computer systems and other devices on which the facility operates.

FIG. 2 is a context diagram showing a determination to be made by the facility in some embodiments.

FIG. 3 is a data flow diagram that describes data exchange in accordance with the facility.

FIG. 4 is a flow diagram showing a process used by the facility in some embodiments to quantify a relationship between an open-source package and a repository.

FIG. 5 is a flow diagram showing a process used by the facility in some embodiments to normalize a package version name and a match between a package version and a repository tag.

FIG. 6 is a graph diagram showing a count of repository tags, a count of package versions, and a count of matches thereof over time between the package and the repository in some embodiments.

FIG. 7 is a display diagram illustrating a sample display presented by the facility in some embodiments to present a relationship score to a user.

### DETAILED DESCRIPTION

Selecting an open-source software package to incorporate into a software project is often an important step in software development. A software project incorporating a package is typically built to interact with various aspects of the package. Therefore, once the software project incorporates the package, the package may be difficult to remove. If the package does not work as intended in the software project or is not properly maintained, the software project may be re-written at great expense to exclude the package, replace various functionality previously provided by the package, or fix problems caused by the package. Worse still, some packages contain malware that may harm computers that execute the software project, or other computer systems with which the package interacts. Such risks highlight the importance of understanding a package's level of safety before using the package in a software project.

Unfortunately, selecting a safe package may be complicated by deceptive practices. Packages typically include self-reported links to source repositories to which they purport to be related. For example, a package created from source code of the NumPy repository conventionally includes a link to the NumPy repository.

These package-repository links are often not validated, however, allowing package creators to link their packages to any repository they desire. As a result, some package creators link packages to popular or reputable repositories to make their packages appear more popular or reputable. For example, a developer with no relation to a popular repository such as Kubernetes may link an unrelated package to Kubernetes to make the package appear popular. Such practices may be difficult for users to detect, making selecting a safe and effective package more difficult.

Conventionally, a developer modifying a project in a source code repository indicates that the project has been modified by tagging the project. Tags are created using a mechanism of the source code repository and are a form of version control. For example, each asset used by a project at a first point in time may be tagged “1.0.0”. When an asset of the project is changed, old assets associated with a previous tag typically remain in the repository, and a new set of assets that reflect any changes made are tagged with a new tag. For example, if a change is made to a project tagged “1.0.0”, the set of assets reflecting the change may be tagged “1.0.1”.

As a project is changed over time, numerous tags are typically made to reflect the changes. Many popular source code repositories immutably record a creation date of each tag. Such dates may often be viewed but not modified. For example, tag “1.0.0” may have a date of Oct. 10, 2023, while tag “1.0.1” may have a date of Dec. 5, 2023. Thus, the project tags reflect a timeline of changes to a project that cannot be easily tampered with.

As changes to the project are made and tagged in the source code repository, corresponding versions of a package of executable code reflecting the changes are also often distributed in a package repository. Such a package version is customarily released to the package repository within a day of when a new tag in the source code repository is created.

The package version is frequently named to include the tag name associated with project assets used to create the package version. For example, a package version created using project assets tagged “1.0.0” in the source code repository may be released to the package repository as “version 1.0.0.” Similarly, a package created using project assets tagged “1.0.1” in the source code repository may be released to the package repository as “version 1.0.1.” Package repositories, like source code repositories, also tend to immutably record a date that each version of the package is released. Thus, project tags from the source code repository are often very similar to corresponding package versions from the package repository, sharing similar names and dates.

In contrast, the inventors have recognized that a package that is not derived from a project does not display these similarities. Such a package is unlikely to include any package versions having a name and date that correspond with a tag name and a tag date of the project. Thus, packages that are derived from a project may be distinguished from packages that are not derived from a project.

In response to recognizing the above disadvantages and characteristics, the inventors have conceived and reduced to practice a software and/or hardware facility for quantifying a relationship between a package and a repository (“the facility”).

In some embodiments, the facility obtains one or more version names and corresponding version dates of a package. The facility identifies a project associated with the package and obtains one or more tag names and corresponding tag dates of the project. The facility determines a count of matching package versions and repository tags, wherein each matching package version and project tag has a matching package version name and project tag name, and a matching package version date and project tag date. The facility then determines a relationship score based on the count of matching package versions and project tags. The relationship score is presented together with content associated with the package.

In some embodiments, the facility determines that the package version date and the project tag date match in response to detecting that the package version date and the project tag date are within a particular period of each other, such as one day.

In some embodiments, the facility determines that the package version name and the repository tag name match in response to detecting that the package version name and the project tag name both match a predetermined regular expression.

In some embodiments, the facility determines the relationship score based on the count of matching package versions and project tags using a piecewise function.

By performing in some or all of the ways described above, the facility computes a relationship score for the package and the project associated with the package that is helpful to determine whether a purported relationship between the package and the repository is accurate. Also, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. For example, by providing a relationship score for a package and an associated repository, the facility reduces computing resources expended on executing unreliable or misrepresented packages.

Further, for at least some of the domains and scenarios discussed herein, the processes described herein as being performed automatically by a computing system cannot practically be performed in the human mind, for reasons that include that the starting data, intermediate state(s), and ending data are too voluminous and/or poorly organized for human access and processing, and/or are a form not perceivable and/or expressible by the human mind; the involved data manipulation operations and/or subprocesses are too complex, and/or too different from typical human mental operations; required response times are too short to be satisfied by human performance; etc. For example, a human mind cannot determine a relationship score of a package and an associated repository in response to viewing content associated with the package.

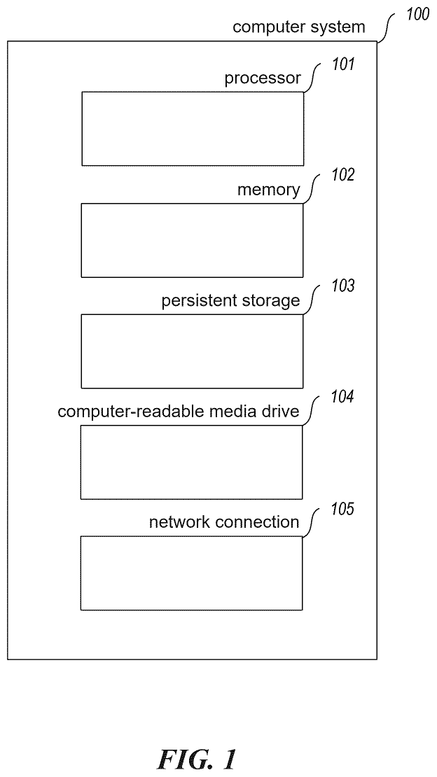

FIG. 1 is a block diagram showing some of the components typically incorporated in at least some of the computer systems and other devices on which the facility operates. In various embodiments, these computer systems and other devices 100 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 101 for executing computer programs and/or training or applying machine learning models, such as a CPU, GPU, TPU, NNP, FPGA, or ASIC; a computer memory 102—such as RAM, SDRAM, ROM, PROM, etc.—for storing programs and data while they are being used, including the facility and associated data, an operating system including a kernel, and device drivers; a persistent storage device 103, such as a hard drive or flash drive for persistently storing programs and data; a computer-readable media drive 104, such as a floppy drive, CD-ROM drive, DVD drive, Universal Serial Bus (USB), etc. for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. None of the components shown in FIG. 1 and discussed above constitutes a data signal per se. While computer systems configured as described above are typically used to support the operation of the facility, those skilled in the art will appreciate that the facility may be implemented using devices of various types and configurations, and having various components.

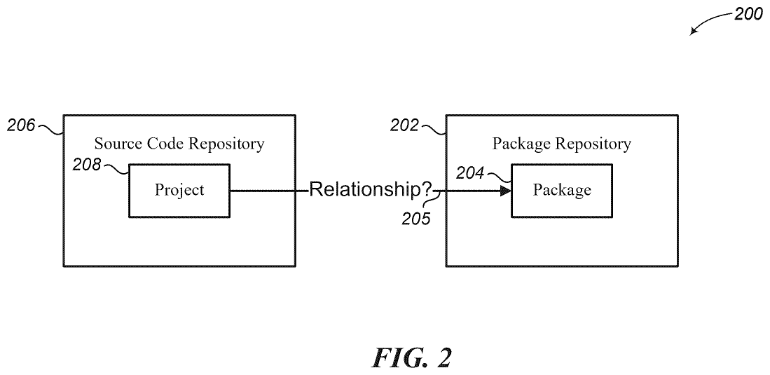

FIG. 2 is a context diagram 200 showing a determination to be made by the facility in some embodiments. As discussed herein, a package such as package 204 may be distributed using a package repository such as package repository 202. Package 202 typically includes an indication of a source code project from which package 202 is derived. In FIG. 2, package 204 is represented as derived from project 208 in source code repository 206, as indicated by arrow 205 from project 208 to package 204. But because a package may be represented as derived from any project the package owner desires, the merely because package 204 is represented as derived from project 208 does not establish the validity of the representation. Embodiments described herein quantify the relationship between package 204 and project 208 to determine the validity of such representations.

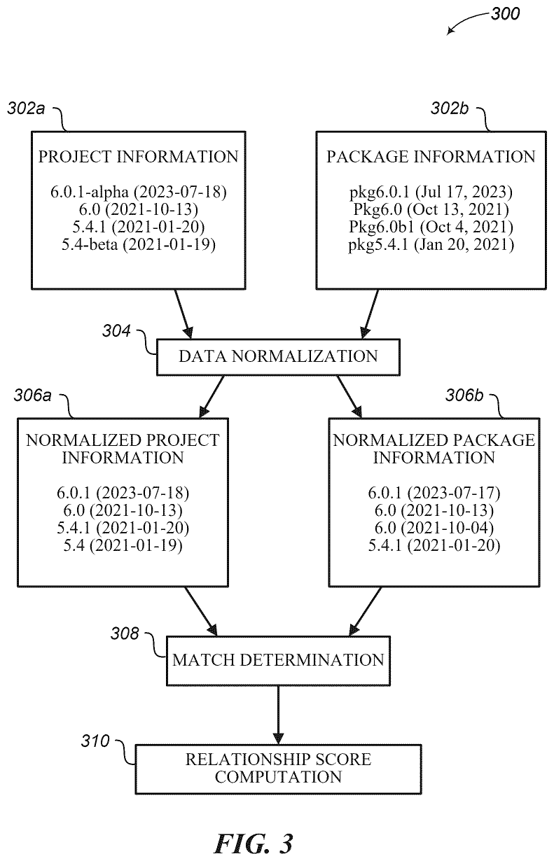

FIG. 3 is a data flow diagram that describes data exchange 300 in accordance with the facility in some embodiments.

As described herein, assets used to create a version of a project in a source code repository are typically tagged using a tagging system provided by the source code repository. When a new version of the source code is released, the assets used to create it are conventionally assigned a new tag signifying their inclusion in the new version. A release date is associated with each tag. Project information 302a is an example of several consecutive tags and corresponding release dates.

Similarly, when a new version of a package is released, the package version is given a name that typically corresponds to the project from which it was derived. Package information 302b includes package versions and corresponding release dates. Similarities exist between project information 302a and package information 302b because the package is, in fact, derived from project source code. For example, repository tag “6.0.1-alpha” has a release date of “Jul. 7-18, 2023,” and “pkg6.0.1” has a release date of “Jul. 17, 2023”. Though the names and dates of the project tags and the package versions are similar, they do not match exactly. For example, the naming schemes vary in that several of the package versions include “pkg” or “Pkg,” whereas the repository tags do not. The date formats are also different. In some embodiments, therefore, the project information and the package information are normalized to enable more effective comparison.

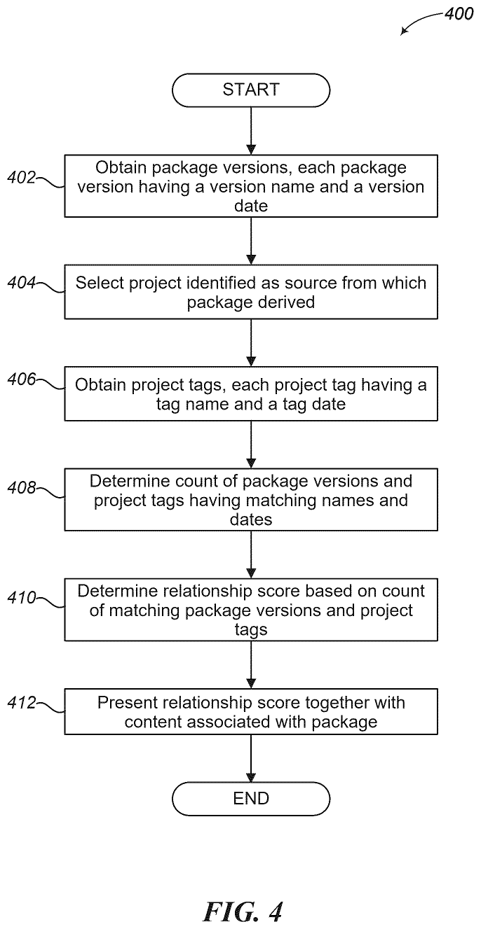

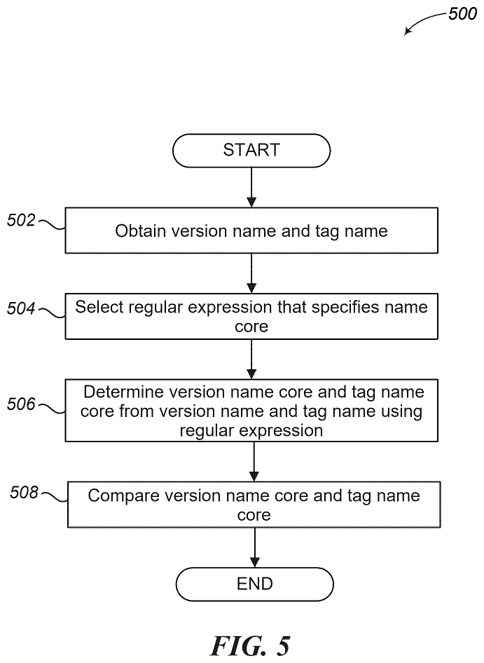

Data normalization 304 transforms project information 302a and package information 302b into a same format, shown in normalized project information 306a and normalized package information 306b. Data normalization is discussed in detail with respect to FIG. 4 and FIG. 5.

The facility uses match determination 308 to compare normalized project information 306a to normalized package information 306b to determine a count of matches between project tags and package versions shown in normalized project information 306a and normalized package information 306b, respectively.

The facility uses relationship score computation 310 to determine a relationship score that indicates a relationship between the project and the package using the count of matches.

FIG. 4 is a flow diagram showing a process 400 used by the facility in some embodiments to quantify a relationship between an open-source package and a repository.

Process 400 begins, after a start block, at block 402, where the facility obtains versions of a package, each package version having a version name and a version date. In some embodiments, the facility obtains the versions of the packages from a package repository that hosts the package. In some embodiments, the facility scrapes the package versions from the package repository, such as by accessing a version list in the package repository. In some embodiments, the facility retrieves the package versions from the package repository using an application programming interface (API) of the package repository. After block 402, process 400 continues to block 404.

At block 404, the facility selects a project identified as a source from which the package is derived. In some embodiments, a repository that hosts the package identifies the project as the source from which the package is derived, such as by a link to the project. The facility may use the link to the project to select the project. After block 404, process 400 continues to block 406.

At block 406, the facility obtains project tags, each project tag having a tag name and a tag date. In some embodiments, the facility obtains the project tags from a list of project releases in the project repository. In some embodiments, the facility obtains the project tags from a list of project tags in the project repository. In some embodiments, the facility scrapes the project tags from the project repository. In some embodiments, the facility receives the project tags from the project repository using an application programming interface (API) of the project repository. After block 406, process 400 continues to block 408.

At block 408, the facility determines a count of package versions and project tags having matching names and dates.

In some embodiments, the facility determines the count of package versions and project tags having matching names and dates by establishing that a version name of the package version and a tag name of the project tag match, and that a version date and a tag date match.

In some embodiments, the facility establishes that the version name of the package version and the tag name of the project tag match by extracting a version name substring from the version name and a tag name substring from the tag name. The facility then compares the version name substring to the tag name substring to establish whether they match. For example, the version name may be “pkg6.0.1” and the tag name may be “6.0.1-alpha”. Though the version name and the tag name share the substring (“6.0.1”), they are not identical. Thus, the facility may normalize the version names and the tag names to improve comparison of the version names and the tag names. In some embodiments, the facility uses a regular expression such as ([0-9] [0-9.] {2,}) to normalize the version name and the tag name. Some embodiments wherein the facility uses a regular expression to establish that the version name and the tag name match are discussed with respect to FIG. 5.

In some embodiments, the facility establishes that the version name and the tag name match using an approximate string-matching algorithm. In some embodiments, the approximate string-matching algorithm determines an edit distance between the version name and the tag name. For example, the edit distance between “6.0.1” and “pkg6.0.1” is three, because a minimum of three single-character edits can be made to “6.0.1” to yield “pkg6.0.1”. In some embodiments, the edit distance is the Levenshtein distance. The facility may use a configurable distance threshold to determine whether the edit distance indicates that the version name and the tag name match. For example, the distance threshold may be 1, 2, 4, 5, etc. The distance threshold may be determined based on a total length of the version name, the tag name, or a combination thereof. For example, a match is not established between a version name of “1” and a tag name of “2”, despite the names having an edit distance of only one because the names are each only one character. In another example, a match is established between a version name of “5.323.762b” and a tag name of “5.323.763” despite having an edit distance of 2 because the names include more characters. In some embodiments, the distance threshold is manually configurable by a user.

In various embodiments, the facility uses any known string-matching algorithm to establish that the version name and the tag name match. In some embodiments, the facility uses a trained machine learning model such as a long short-term memory (LSTM) to establish that the version name and the tag name match. In some embodiments, the facility uses a fuzzy matching technique such as probabilistic record linkage to establish that the version name and the tag name match. After block 408, process 400 continues to block 410.

In some embodiments, the facility determines whether the version date and the tag date match using the methods described herein with respect to determining whether the tag name and the version name match. For example, when the tag date is “Oct. 5, 2023”, and the version date is “10/6/2023”, the dates may be normalized to improve comparison of the dates.

In some embodiments, the facility establishes that the tag date and the version date match if they are within a configurable threshold period of time of each other such as one day, a week, etc. Because corresponding package versions and project source code are not always released at the same time, including a configurable threshold period of time may avoid undercounting matching version dates and tag dates. For example, an administrator of a project may release project source code to a repository about a day before or after the administrator releases a package version to a package repository.

At block 410, the facility determines a relationship score based on the count of matching package versions and project tags. In general, the relationship score reflects a likelihood that the package is derived from source code of the project. In some embodiments, the relationship score is the count of matching package versions and project tags. In some embodiments, the count of matching package versions and project tags is mapped to a relationship score in the set [0,10], [0,100], etc.

In some embodiments, the facility uses a variety of stepwise functions to determine the relationship score based on the count of matching package versions and project tags. For example, the facility may use a stepwise function in which: the relationship score is 2 when the count of matching package versions and projects tags is zero; the relationship score is 5 when there are no project tags to which the package versions may be compared; the relationship score is 8 when the count of matching package versions and project tags is at least one; and the relationship score is 10 when the package is cryptographically signed by an administrator of the project. Cryptographic signature of the package by the administrator of the project may be considered conclusive evidence that the package is derived from source code of the project. Sigstore® is an example of a system enabling cryptographic signature of the package by the administrator of the project.

In various embodiments, the facility uses a variety of stepwise functions to determine the relationship score using the count of matching package versions and project tags. In some embodiments, a user may customize the various conditions of the stepwise function used to map the count of matching package versions and project tags to the relationship score. For example, the conditions may be customized to assign high relationship scores to package-project pairs that have a higher or lower number of matching package versions and project tags, eliminate or add various conditions or relationship scores, map conditions to different relationship scores, etc.

In various embodiments, the facility uses a variety mappings from the count of matching package versions and project tags to the relationship score. In some embodiments, the relationship score is calculated based on a proportion of package versions for which for which a matching project tag exists. For example, when a package has 100 versions and 20 of the versions match project tags, the proportion of package versions for which a matching project tag exists is 20%. The facility may map the proportion to the relationship score using a stepwise function, a linear function, or any other mapping.

In some embodiments, the facility calculates the relationship score based on an entropy calculated for the package versions and the project tags. For example, the facility may calculate a matching portion of package versions with matching project tags, such as by dividing the count of matching package versions and project tags by a total number of package versions. The facility may then use the matching portion as input to a binary entropy function to determine an entropy. The facility then calculates the relationship score based on the entropy. In some embodiments, the facility calculates the relationship score based on calculating an entropy of the project tag dates and the package version dates. After block 410, process 400 continues to block 412.

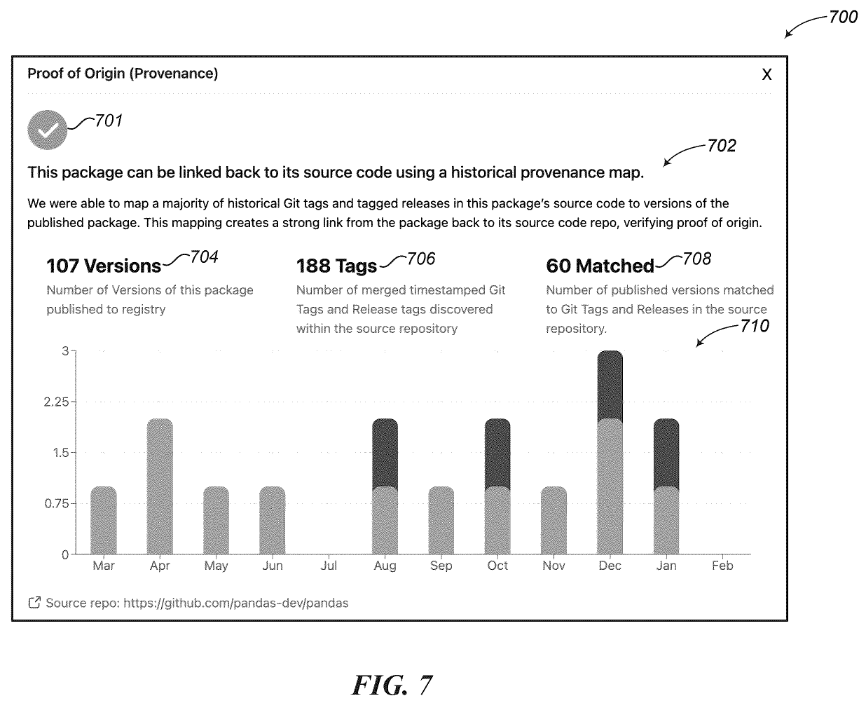

At block 412, the facility presents the relationship score together with content associated with the package. An example display used by the facility to present the relationship score together with content associated with the package according to some embodiments is shown in FIG. 7. In some embodiments, the facility presents the relationship score as a graphical icon based on the relationship score. In some embodiments, the facility displays a positive indication such as a green checkmark when the relationship score is above a first threshold such as 5. In some embodiments, the facility displays a negative indication such as a red X mark when the relationship score is below a second threshold such as 2. In some embodiments, the first threshold and the second threshold are the same.

In various embodiments, the content associated with the package is a count of package versions, a count of project tags of the project from which the package is identified as derived, a count of matching package versions and project tags, a visualization thereof, etc. In some embodiments, the facility uses the relationship score to determine a reliability of the package. After block 412, process 400 ends at an end block.

While process 400 is described in terms of determining a relationship score for a single package, the disclosure is not so limited. In various embodiments, the facility uses embodiments of process 400 to determine relationship scores for multiple packages. For example, when multiple packages link to a selected repository, the facility may calculate a relationship score between each of the multiple packages and the selected repository. The packages may be displayed in an order based on their respective relationship score, such as from highest relationship score to lowest relationship score. The facility thereby enables users to quickly determine which packages that link to the selected repository are derived from the selected repository.

Those skilled in the art will appreciate that the acts shown in FIG. 4 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

FIG. 5 is a flow diagram showing a process 500 used by the facility in some embodiments to normalize a package version name and a project tag name for comparison. Embodiments of block 408 of FIG. 4 use process 500 to determine a count of package versions and project tags having matching names and dates. Process 500 begins, after a start block, at block 502, where the facility obtains a version name and a tag name.

In some embodiments, the facility obtains the version name in response to selection of a package for which a relationship with a repository is to be quantified. The version name is a name of a version of the package. Various version names are shown in package information 302b of FIG. 3.

In some embodiments, the facility obtains the tag name in response to selecting a repository from which the project is identified as derived. The tag name is a name of a tag of the repository. Various tag names are shown in project information 302a of FIG. 3. After block 502, process 500 continues to block 504.

At block 504, the facility selects a regular expression that specifies a name substring. As discussed herein, a package version name and a project tag name may not be identical even when they match. Thus, in process 500, a regular expression is selected to extract a name substring from the package version name and the project tag name for comparison. A regular expression defines a pattern to match in input characters. For example, a regular expression that matches commonly used version names such as “6.0.1” or “7.2.3” or “6.0b” may be given as a first regular expression:
([0-9] [0-9.] {2,})

Version and tag naming often matches the first regular expression. In some embodiments, therefore, the facility selects the first regular expression or a variant thereof to normalize the package version name and the project tag name.

Not all software versioning schema match the first regular expression. For example, the version name or tag name may include “6”, “6b”, “6.1.2b.3”, etc., or may follow various other software versioning schema. In some embodiments, the facility attempts to match several regular expressions that match common software versioning schema. The facility then selects a regular expression that matches the version name, the tag name, or both. In some embodiments wherein the facility determines that the version name, the tag name, or both do not follow a common software versioning schema, the facility does not select the regular expression. In some embodiments, therefore, the version name substring is the version name, the tag name substring is the tag name, or both. After block 504, process 500 continues to block 506.

At block 506, the facility determines a version name substring of the version name and a tag name substring of the tag name using the regular expression.

For example, the version name “pkg6.0.1” and tag name “6.0.1” share a name substring of 6.0.1 that has a form that may be described using the first regular expression:
([0-9] [0-9.] {2,})

A search for characters matching the first regular expression in “pkg6.0.1” and “6.0.1” yields “6.0.1” in each case. Thus, the version name substring is “6.0.1” and the tag name substring is “6.0.1”. After block 506, process 500 continues to block 508.

At block 508, the facility compares the version name substring and the tag name substring. In some embodiments, the facility compares the version name substring and the tag name substring using an approximate string-matching algorithm such that the version name substring and the tag name substring may match when they are not identical. In various embodiments, block 506 employs applicable aspects of embodiments of block 408 to determine whether the version name substring and the tag name substring match. After block 508, process 500 ends at an end block.

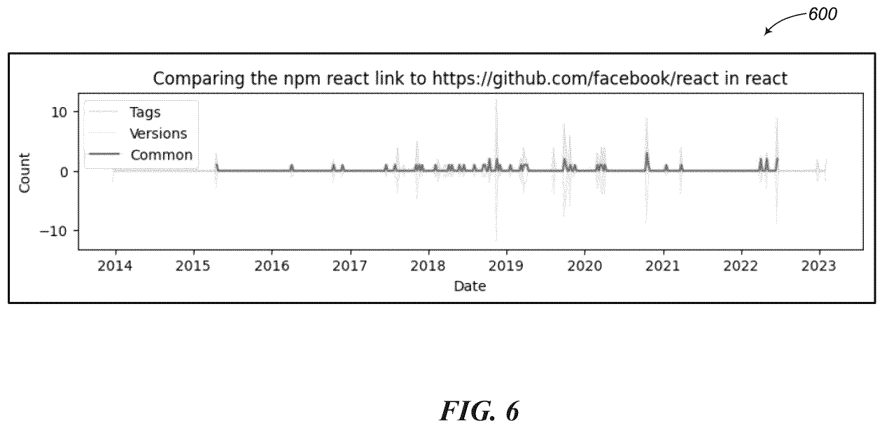

FIG. 6 is a graph diagram 600 showing a count of repository tags, a count of package versions, and a count of matches thereof over time between the package and the repository. FIG. 6 shows matching tags and versions for a project-package pair. In some embodiments, a count of matches over time greater than zero indicates that the package is derived from the project. In some embodiments, therefore, not every project tag and package version must match to confirm that the package is derived from the repository.

FIG. 7 is a display diagram illustrating a sample display 700 presented by the facility in some embodiments to provide a relationship score to a user. Sample display 700 includes a relationship indicator 701, relationship summary 702, package information 704, project information 706, match information 708, and data visualization 710.

Relationship indicator 701 indicates a relationship status of a package-project pair. Relationship indicator 701 is based on a relationship score, such as a relationship score produced using embodiments of process 400 of FIG. 4. The relationship indicator 701 depicted in FIG. 7 is a green checkmark, indicating that the package is derived from the repository. In various embodiments, relationship indicator 701 varies based on the relationship score. In some embodiments, when the relationship score is less than a first score threshold, relationship indicator 701 may be a red X mark; when the relationship score is more than the first score threshold and less than a second score threshold, the relationship indicator is a yellow caution mark; and when the relationship score is greater than the second threshold, the relationship indicator is a green check mark. In some embodiments, relationship indicator 701 is the relationship score. For example, the relationship score may be 2, 5, 8, 10, etc. In some embodiments, relationship indicator 701 is based on one or more of package information 704, project information 706, or match information 708. For example, relationship indicator 701 may be based on a portion of package versions for which a matching project tag is established.

In some embodiments, relationship summary 702 is a text-based summary of the relationship score. As depicted in FIG. 7, relationship summary 702 describes that the relevant package was derived from the relevant project source code.

Package information 704 includes information about the package. As depicted in FIG. 7, package information 704 includes a number of published versions of the package. In various embodiments, package information 704 includes other information about the package such as an initial release date, a link to the package, a number of downloads of the package, contributors to the package, etc.

Project information 706 includes information about the project. As depicted in FIG. 7, project information 706 includes a count of tags associated with the project. In various embodiments, project information 706 includes other information about the project, such as an initial release date, a link to the project, an indication of an amount of positive feedback of the project, etc.

Match information 708 includes information about a count of matches between versions of the package and tags of the project. In various embodiments, match information 708 includes a proportion of matches between versions of the package and tags of the project to a total number of project tags, package versions, or both.

Data visualization 710 includes one or more visualizations of package information 704, project information 706, match information 708, or a combination thereof. In some embodiments, data visualization is configured to include a visualization based on user input.

While FIG. 7 shows a display whose formatting, organization, informational density, etc., is best suited to certain types of display devices, those skilled in the art will appreciate that actual displays presented by the facility may differ from those shown, in that they may be optimized for particular other display devices, or have shown visual elements omitted, visual elements not shown included, visual elements reorganized, reformatted, revisualized, or shown at different levels of magnification, etc.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
selecting a package of an executable software exchange;
obtaining, from the executable software exchange, package versions established for the package, each package version having a version name and a version date;
selecting a project of a source code exchange, wherein the project is identified by the package as a source from which the package is derived;
obtaining project tags established for the project, each project tag having a tag name and a tag date;
determining a count of each matching package version and project tag, wherein a match of a package version and a project tag is determined by:
establishing that a version name of the package version and a tag name of the project tag match; and
establishing that a version date of the package version and a tag date of the project tag match; and
determining a relationship score based on the count of each matching package version and project tag; and
in response to detecting that a user is viewing content associated with the package, causing an indication of the relationship score to be presented together with the content associated with the package.

2. The method of claim 1, wherein determining the relationship score is further based on a total count of the obtained project tags.

3. The method of claim 1, wherein establishing that the version date of the package version and the tag date of the project tag match comprises:
determining that the version date of the package version and the tag date of the project tag are within a configurable time threshold of each other.

4. The method of claim 1, wherein establishing that the version name of the package version and the tag name of the project tag match comprises:
obtaining an operation to extract a version name substring from the version name and a tag name substring from the tag name;
extracting, using the operation, the version name substring and the tag name substring; and
comparing the version name substring to the tag name substring.

5. The method of claim 4, wherein obtaining the operation to extract the version name substring from the version name and the tag name substring from the tag name comprises:
obtaining a regular expression to extract the version name substring from the version name and the tag name substring from the tag name.

6. The method of claim 1, wherein establishing that the version name of the package version and the tag name of the project tag match comprises:
obtaining an approximate string-matching algorithm to compare the version name and the tag name; and
comparing the version name and the tag name using the approximate string-matching algorithm.

7. The method of claim 1, further comprising, before establishing that a version name of the package version and the tag name of the project tag match, normalizing the version name and the tag name.

8. The method of claim 1, wherein determining the relationship score uses a step function.

9. The method of claim 1, wherein causing the indication of the relationship score to be presented together with the content associated with the package comprises:
causing a graphical indication of the relationship score to be displayed to the user.

10. The method of claim 1, wherein establishing that the version date of the package version and the tag date of the project tag match comprises:
establishing that the version date and the tag date are within one calendar day of each other.

11. The method of claim 1, wherein determining the relationship score comprises:
determining the relationship score based on whether the package version is cryptographically signed by an owner of the project repository.

12. A system comprising:
one or more processors; and
one or more storage devices that store instructions executable by the one or more processors to cause the one or more processor to perform actions, the actions comprising:
selecting a package of a repository for executable software;
obtaining, from the repository for executable software, package versions established for the package, each package version having a version name and a version date;
determining a project that the package identifies as a source from which the package is derived;
locating, in a repository for source code, the project;
obtaining, from the repository for source code, project tags established for the project, each project tag having a tag name and a tag date;
determining that a package version of the package versions and a project tag of the project tags match by:
establishing that a version name of the package version and a tag name of the project tag match; and
establishing that a version date of the package version and a tag date of the project match; and
determining a relationship score in response to determining that the package version and the project tag match.

13. The system of claim 12, wherein the one or more processors establish that the version name of the package version and the tag name of the project match by:
obtaining an operation to extract a version name substring from the version name and a tag name substring from the tag name;
extracting, using the operation, the version name substring and the tag name substring; and
determining that the version name substring and the tag name substring match.

14. The system of claim 12, wherein the one or more processors obtain the operation to extract the version name substring from the version name and the tag name substring from the tag name by:
attempting to match the version name to a plurality of regular expressions; and
selecting, as the operation, a regular expression in the plurality of regular expressions that matches the version name.

15. The system of claim 12, wherein the one or more processors establish that the version name of the package version and the tag name of the project tag match by:
selecting an approximate string-matching algorithm to compare the version name and the tag name; and
comparing the version name and the tag name using the approximate string-matching algorithm.

16. The system of claim 12, wherein the one or more processors establish that the version date of the package and the tag date of the project match by:
establishing that the tag date and the version date are within two days of each other.

17. One or more computer-readable media that store instructions that are executable by one or more processors to cause the one or more processors to perform actions, the actions comprising:
selecting a package;
obtaining, from a repository for executable software, package versions established for the package, each package version having a version name and a version date;
identifying a project that is represented to be a source from which the package is derived;
obtaining, from a repository for source code, project tags established for the project, each project tag having a tag name and a tag date;
determining that a package version of the package versions and a project tag of the project tags match by:
establishing that a version date of the package version and a tag date of the project match; and
determining a relationship score in response to determining that the package version and the project tag match.

18. The one or more computer-readable media of claim 17, wherein establishing that the version date of the package version and the tag date of the project tag match comprises:
selecting an approximate string-matching algorithm to compare the version date and the tag date; and
comparing the version date and the tag date using the approximate string-matching algorithm.

19. The one or more computer-readable media of claim 17, further executable to cause the one or more processors to perform actions, the actions comprising:
calculating a reliability of the package using the relationship score.

20. The one or more computer-readable media of claim 17, wherein determining the relationship score comprises:
calculating a matching portion of package versions that match a project tag;
computing an entropy based on the matching portion using a binary entropy function; and
determining the relationship score based on the entropy.
